(19) United States
(12) Patent Application Publication
(10) Pub. No.: US 2006/0200807 A1
(43) Pub. Date: Sep. 7, 2006

(54) Breakpoint timers

(75) Inventors: Cary Lee Bates, Rochester, MN (US); Paul Reuben Day, Rochester, MN (US); Brian Robert Muras, Rochester, MN (US); John Matthew Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/071,090

(22) Filed: Mar. 3, 2005

(51) Int. Cl. G06F 9/44

(52) U.S. Cl. 717/129

(57) ABSTRACT

A method, apparatus, system, and signal-bearing medium that, in an embodiment, start a timer in response to a program encountering a first breakpoint and halt the program at a second breakpoint if the timer exceeds a condition. If the timer does not exceed the condition, the program is resumed. In various embodiments, the condition may be a value retrieved from the program based on a keyword and may further include a threshold. In another embodiment, after the timer exceeds the condition an interrupt is raised and in response the program counter for the program is changed to be a specified statement. In an embodiment, a loop entry breakpoint is set at a loop entry statement in the program, a loop body breakpoint is set at a loop body statement in the program, and a loop exit breakpoint is set at a loop exit statement in the program. A timer is then started for an iteration period in response to the program encountering the loop entry breakpoint. The timer is reset to the iteration period in response to the program encountering the loop body breakpoint. The timer is canceled in response to the program encountering the loop exit breakpoint.

### FIELD

An embodiment of the invention generally relates to computers. In particular, an embodiment of the invention generally relates to breakpoint timers.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

As the sophistication and complexity of computer software increase, the more difficult the software is to debug. Bugs are problems, faults, or errors in a computer program. Locating, analyzing, and correcting suspected faults in a computer program is a process known as “debugging.” Typically, a programmer uses another computer program commonly known as a “debugger” to debug the program under development.

Conventional debuggers typically support two primary operations to assist a computer programmer. A first operation supported by conventional debuggers is a “step” function, which permits a computer programmer to process instructions (also known as “statements”) in a computer program one-by-one and see the results upon completion of each instruction. While the step operation provides a programmer with a large amount of information about a program during its execution, stepping through hundreds or thousands of program instructions can be extremely tedious and time consuming and may require the programmer to step through many program instructions that are known to be error-free before a set of instructions to be analyzed is finally executed.

To address this difficulty, a second operation supported by conventional debuggers is a breakpoint operation, which permits a computer programmer to identify with a breakpoint a precise instruction for which it is desired to halt execution of a computer program during execution. As a result, when a computer program is executed by a debugger, the program executes in a normal fashion until the breakpoint is reached. The debugger then stops execution of the program and displays the results of the program and/or the state of the computer system to the programmer for analysis, typically via a debugger user interface.

Typically, step operations and breakpoints are used together to simplify the debugging process. Specifically, a common debugging operation is to set a breakpoint at the beginning of a desired set of instructions to be analyzed and then begin executing the program. Once the breakpoint is reached, the debugger halts the program, and the programmer then steps through the desired set of instructions line-by-line using the step operation. Consequently, a programmer is able to more quickly isolate and analyze a particular set of instructions without needing to step through irrelevant portions of a computer program.

Although conventional breakpoints can work well for conventional programs, computers increasingly use applications and operations that are timing dependent. One example of a timing dependent application is one that uses multiple server tasks, which can hang and then timeout, leaving corrupted data as the application continues on. Another example is an application that experiences performance problems, such as an application with a long running loop, query, query optimization, or other operation. Debugging problems with these kind of applications can be particularly difficult because timing and performance problems do not occur at regular intervals, and the developer often experiences difficulty determining precisely when the application started to hang or which operation is the source of the performance problem. One technique for dealing with such problems is to insert manual breakpoints near the application location where the developer speculates the hang or performance problem might occur, let the application run, and then manually resume the application as each breakpoint is encountered until the application hangs or encounters a long-running operation. Unfortunately, not only is this an arduous process, but the breakpoints can change the timing of the application, which makes reproducing the problem even more difficult.

Hence, without a better way to handle reproducing timing and performance problems, developers will continue to experience delay, frustration, and difficulty when debugging programs.

### SUMMARY

A method, apparatus, system, and signal-bearing medium are provided that, in an embodiment, start a timer in response to a program encountering a first breakpoint and halt the program at a second breakpoint if the timer exceeds a condition. If the timer does not exceed the condition, the program is resumed. In various embodiments, the condition may be a value retrieved from the program based on a keyword and may further include a threshold. Further, the condition may be an estimate of an execution time of an operation performed by the program, or a function of historical execution times of operations performed by the program. In an embodiment, after the timer exceeds the condition an interrupt is raised. In response, the program counter for the program is changed to be a specified statement. In this way, a program may be conditionally halted at breakpoints based on a timer, which allows for the program to be debugged more easily.

In an embodiment, a loop entry breakpoint is set at a loop entry statement in the program, a loop body breakpoint is set at a loop body statement in the program, and a loop exit breakpoint is set at a loop exit statement in the program. A timer is then started for an iteration period in response to the program encountering the loop entry breakpoint. The timer is reset to the iteration period in response to the program encountering the loop body breakpoint. The timer is canceled in response to the program encountering the loop exit breakpoint. If the timer fires, the debugger halts the program. In this way, if a loop executes slower than the iteration period, the program may be halted to allow for debug.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of selected components of the example system, according to an embodiment of the invention.

FIG. 3 depicts a block diagram of example user interface breakpoint commands, according to an embodiment of the invention.

FIG. 4 depicts a block diagram of an example breakpoint table, according to an embodiment of the invention.

FIG. 5 depicts a flowchart of example processing for handling debug commands, according to an embodiment of the invention.

FIG. 6 depicts a flowchart of example processing for handling breakpoints, according to an embodiment of the invention.

FIG. 7 depicts a flowchart of example processing for handling interrupts, according to an embodiment of the invention.

FIG. 8 depicts a flowchart of example processing for handling loop breakpoints, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, a debugger starts a timer in response to a program encountering a first breakpoint and halts the program at a second breakpoint if the timer exceeds a condition. If the timer does not exceed the condition, the debugger resumes. In various embodiments, the condition may be a value that the debugger retrieves from the program based on a keyword and may further include a threshold. The keyword may be specified on a debug command. In various embodiments, the condition may be an estimate of an execution time of an operation performed by the program, or a function of historical execution times of operations performed by the program. In various embodiments, the function may be an average, a standard deviation, or any other appropriate function.

In another embodiment, the debugger may initialize a timer to interrupt the program after the timer exceeds an interrupt condition, and in response to the interrupt, the debugger changes the program counter to be a specified statement in the program. If the program reaches the specified statement without the timer exceeding the interrupt condition, the debugger deactivates the timer.

In another embodiment, the debugger sets a loop entry breakpoint at a loop entry statement in the program, a loop body breakpoint at a loop body statement in the program, and a loop exit breakpoint at a loop exit statement in the program. The debugger then starts a timer for an iteration period in response to the program encountering the loop entry breakpoint. The debugger resets the timer to the iteration period in response to the program encountering the loop body breakpoint. The debugger cancels the timer in response to the program encountering the loop exit breakpoint. If the timer fires, the debugger halts the program. In this way, if the loop executes slower than the iteration period, the debugger halts the program to allow debug of the program.

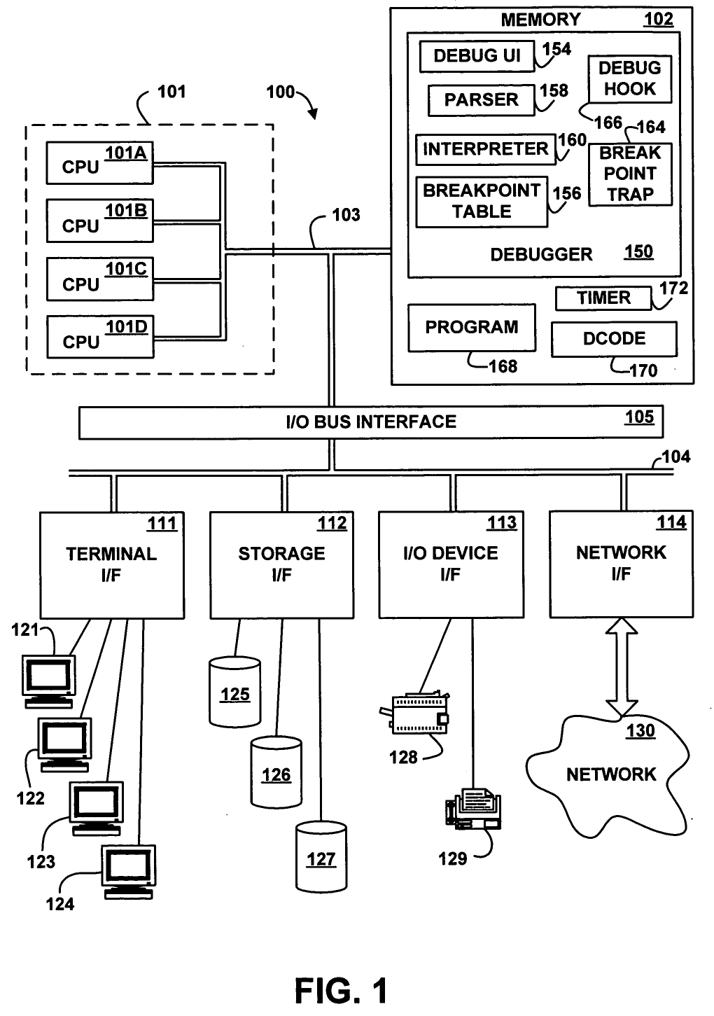

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a debugger 150, a program 168, dcode 170, and a timer 172. Although the debugger 150, the program 168, the dcode 170, and the timer 172 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the debugger 150, the program 168, the dcode 170, and the timer 172 are illustrated as being contained within the main memory 102, these elements are not necessarily all completely contained in the same storage device at the same time.

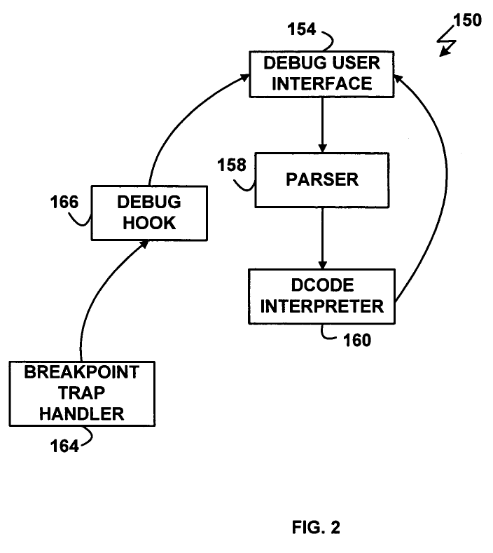

The debugger 150 includes a debug user interface 154, a breakpoint table 156, a parser 158, an interpreter 160, a breakpoint trap handler 164, and a debug hook 166. In an embodiment, the debug user interface 154 and the interpreter 160 include instructions capable of executing on the processor 101 or statements capable of being interpreted by instructions executing on the processor 101 to perform the functions as further described below with reference to FIGS. 2, 3, 4, 5, 6, 7, and 8. In another embodiment, the debug user interface 154 and the interpreter 160 may be implemented in microcode. In another embodiment, the debug user interface 154 and the interpreter 160 may be implemented in hardware via logic gates and/or other appropriate hardware techniques.

The program 168 is a program being debugged. The program 168 may be any type of executable or interpretable code or statements, whether in source or object form. In the various embodiments, the program 168 may be an application program, an operating system program, a network application, a scientific calculation manager, a query optimizer, or any other type of program.

The parser 158 evaluates debug commands from the debug user interface 154 to create the dcode 170, which the interpreter 160 interprets for execution on the processor 101. The dcode 170, when executed by the interpreter 160 on the processor 101, encounters the breakpoint set by the debug user interface 154. The interaction of the debug user interface 154, the parser 158, the interpreter 160, the breakpoint trap handler 164, and the debug hook 166 are further described below with reference to FIG. 2.

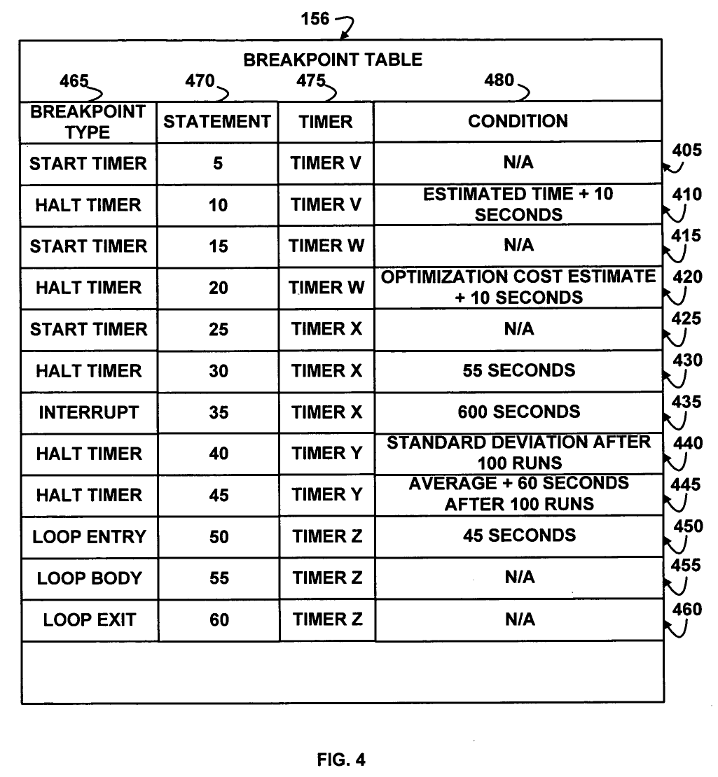

The breakpoint table 156 includes information regarding breakpoints set in the program 168. The breakpoint table 156 is further described below with reference to FIG. 4. The timer 172 may be initialized to a specified starting value and count down to zero, at which time the timer fires. In another embodiment, the timer 172 may be initialized to zero and count up to either a specified threshold or indefinitely until the timer is reset. Regardless of whether the timer 172 counts up or down, the current value (the current count or time) of the timer 172 may be read by the debugger 150. Multiple instances of the timer 172 may time different events and may be referred to with different names. Although the timer 172 is illustrated as being a software timer included within the memory 102, in another embodiment, the timer 172 may be a hardware timer.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD−R, or DVD+R;

(2) alterable information stored on a rewriteable storage medium, e.g., a hard disk drive (e.g., the DASD 125, 126, or 127), CD-RW, DVD−RW, DVD+RW, DVD-RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of selected components of the example system, according to an embodiment of the invention. Illustrated are the debug user interface 154, the parser 158, the interpreter 160, the breakpoint trap handler 164, and the debug hook 166.

The debug user interface 154 provides breakpoints to be established by interacting with a user. In some embodiments, the user may define these breakpoints by issuing a debugger command that refers to high-level language (HLL) references in the program 168 (FIG. 1), such as line or statement numbers or software object references such as a program or module name, from which the physical storage address may be cross referenced. In various embodiments, the debugger command may be issued on a command line or through a graphical user interface.

The parser 158 parses this debugger command using a table that was produced by a compiler or interpreter stored with the computer program 168 to map the line number in the debugger command to the actual physical storage address in the memory 102. The dcode interpreter 160 stores this information in the breakpoint table 156. The dcode interpreter 160 further runs a dcode program to interpret instructions in the dcode 170 and to set the breakpoints in the program 168.

After the breakpoints are set, the user provides an input to the debug user interface 154 that resumes execution of the program 168. Execution of the program 168 eventually results in an encounter of a breakpoint. In an embodiment, this is accomplished by an instruction that fails, causing a system exception. The breakpoint trap handler 164 passes information regarding the exception or interrupt to the debug hook 166.

Then, the debug user interface 154 utilizes the debug hook 166 in order to obtain debugger commands, especially when a breakpoint has halted program execution. The additional step of the debug hook 166 is illustrated for instances where an interface is required between the debug user interface 154 and the breakpoint trap handler 164. In an embodiment, the debug hook 166 may utilize an unillustrated result buffer to cache data for the debug user interface 154.

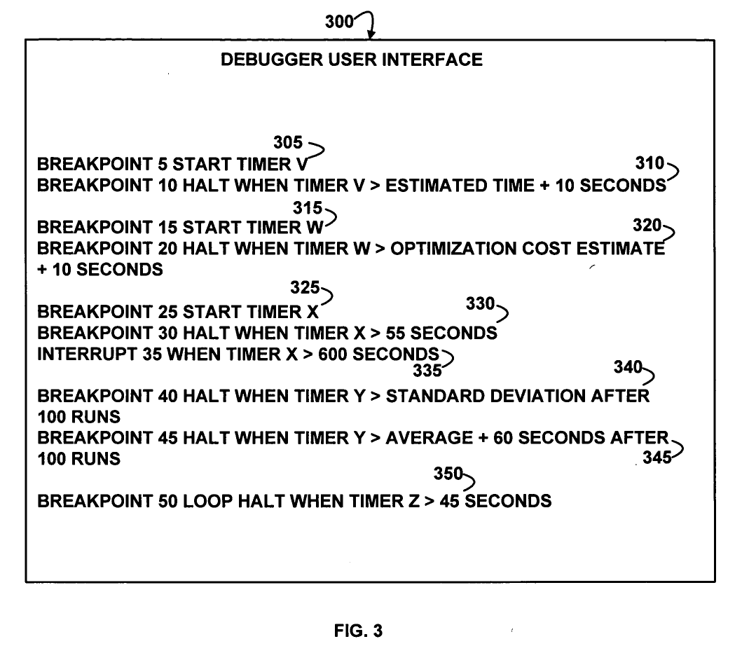

FIG. 3 depicts a block diagram of example user interface 300, including breakpoint commands, according to an embodiment of the invention. The example user interface 300 may be presented via the debug user interface 154. Although the example user interface 300 is illustrated as a user command interface, in another embodiment a graphical interface, a speech-recognition interface, an application program interface, or any other appropriate interface may be used.

The example user interface 300 includes commands 305, 310, 315, 320, 325, 330, 335, 340, 345, and 350, which request the debugger 150 to set breakpoints or interrupts within the program 168. The command 305 requests the debugger 150 to set a breakpoint at statement “5” of the program 168, which when encountered causes the debugger 150 to start a timer named “timer v.” The command 310 requests the debugger 150 to set a breakpoint at the statement “10” within the program 168, which when encountered causes the debugger 150 to only stop the execution of the program 168 if the current value of the timer named “timer v” exceeds the keyword “estimated time” plus the threshold of “10 seconds.” The debugger 150 obtains the value for the keyword from the program 168. The keyword “estimated time” is an example only, and any appropriate keyword may be used. The keyword “estimated time” refers to the estimated execution time for an operation associated with the program 168 and may refer to the estimated execution time of a query, a calculation, a network response time, or any other appropriate operation time.

The command 315 requests the debugger 150 to set a breakpoint at statement “15” of the program 168, which when encountered causes the debugger 150 to start a timer named “timer w.” The command 320 requests the debugger 150 to set a breakpoint at the statement “20” within the program 168, which when encountered causes the debugger 150 to only stop the execution of the program 168 if the current value of the timer named “timer w” exceeds the keyword “optimization cost estimate” plus the threshold of “10 seconds.” The debugger 150 obtains the value for the keyword from the program 168. The keyword “optimization cost estimate” is an example only, and any appropriate keyword may be used. The keyword “optimization cost estimate” refers to the estimated optimization time for an operation associated with the program 168 and may refer to the estimated optimization time of a query or any other appropriate operation.

The command 325 requests the debugger 150 to set a breakpoint at statement “25” of the program 168, which when encountered causes the debugger 150 to start a timer named “timer x.” The command 330 requests the debugger 150 to set a breakpoint at the statement “30” within the program 168, which when encountered causes the debugger 150 to only stop the execution of the program 168 if the current value of the timer named “timer x” exceeds a threshold of 55 seconds at the time the statement “30” is encountered by the program 168. The threshold of 55 seconds is an example only, and any appropriate threshold may be used. The command 335 requests the debugger 150 to interrupt the operation of the program 168 at the statement “35” if the value of the timer “timer x” exceeds the threshold “600 seconds.”

The command 340 requests the debugger 150 to stop the program 168 at the statement “40” after the value of the timer “timer y” exceeds the condition of the keyword “standard deviation” of the time consumed by operations of the program 168 after the threshold “100” number of operations. The debugger 150 obtains the value of the keyword from the program 168. Thus, in this example, the program 168 keeps a history of the amount of time that the program operations consume over a number of operations, which in this example is “100” operations. The command 345 requests the debugger 150 to stop the program 168 at the statement “45” after the value of the “timer y” exceeds the condition of the keyword “average” of the time consumed by operation of the program 168 after the threshold “100” number of operations. The debugger 150 obtains the value of the keyword from the program 168. The keywords “standard deviation” and “average” are examples only, and in other embodiments the debugger 150 may obtain any appropriate history values from the program 168.

The command 350 requests the debugger 150 to examine a program loop within the program 168 that starts at statement “50” and establish the timer “timer z,” such that if the program loop does not complete within the specified iteration period of “45 seconds,” the timer “timer z” fires and control is given to the debugger 150, which pauses the program 168 and presents the debug user interface 154. In various embodiments, a program loop may be a while loop, a do-until loop, or any other appropriate program loop. The command 350 causes the debugger 150 to create a breakpoint at the entry of the loop, a breakpoint in the body of the loop, and a breakpoint at the exit of the loop. When the breakpoint at the entry of the loop is encountered by the execution of the program 168, the debugger 150 starts the timer “timer z.” When the breakpoint in the loop body is encountered by the execution of the program 168, the debugger 150 resets the timer “timer z” if the timer has not fired. When the breakpoint at the loop exit is encountered by the execution of the program 168, the debugger 150 cancels the timer “timer z.”

FIG. 4 depicts a block diagram of the example breakpoint table 156, according to an embodiment of the invention. The breakpoint table 156 is illustrated as including records 405, 410, 415, 420, 425, 430, 435, 440, 445, 450, 455, and 460, but in other embodiments, any number of records with any appropriate data may be present. The debugger 150 creates the records in the breakpoint table 156 in response to the commands initiated via the debugger user interface 300, as previously described above with reference to FIG. 3.

Each of the records includes a breakpoint type field 465, a statement field 470, a timer identifier field 475, and a condition field 480, but in other embodiments the records may include more or fewer fields with any appropriate field names. The breakpoint type field 465 indicates the type of the breakpoint associated with the record. The statement field 470 indicates the statement in the program 168 at which the breakpoint is set. The timer identifier field 475 identifies the name or other identifier of the timer 172 associated with the breakpoint. The condition field 480 indicates a condition, which may include a keyword and/or a threshold that the debugger 150 compares against the value of the timer 475.

The record 405 corresponds to the command 305. The record 410 corresponds to the command 310. The record 415 corresponds to the command 315. The record 420 corresponds to the command 320. The record 425 corresponds to the command 325. The record 430 corresponds to the command 330. The record 435 corresponds to the command 335. The record 440 corresponds to the command 340. The record 445 corresponds to the command 345. The records 450, 455, and 460 correspond to the command 350.

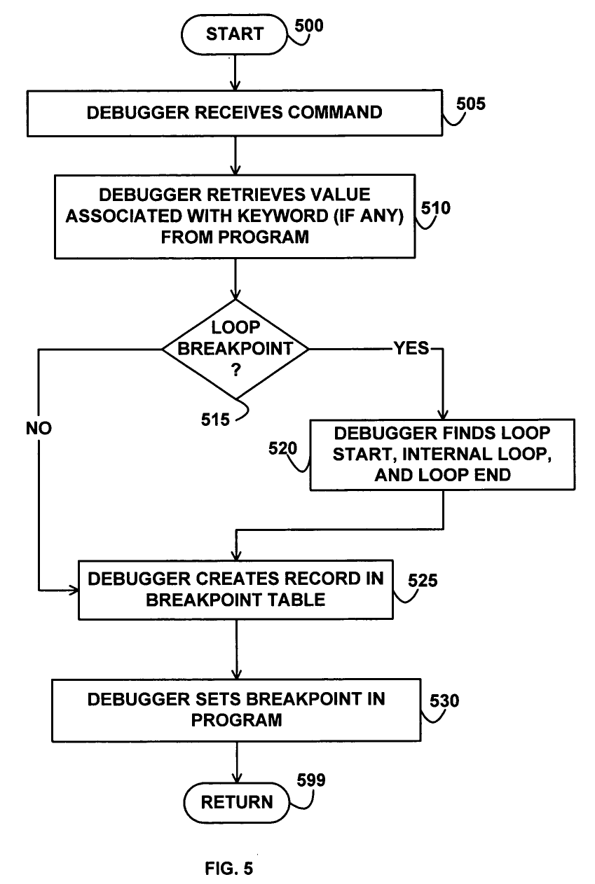

FIG. 5 depicts a flowchart of example processing for handling debug commands, according to an embodiment of the invention. Control begins at block 500. Control then continues to block 505 where the debugger 150 receives a command from the user interface 300. Control then continues to block 510 where the debugger 150 retrieves the value associated with any keyword in the received command from the program 168. Examples of keywords, previously described above with reference to FIGS. 3 and 4, are the estimated time keyword in the record 410, the optimization cost estimate keyword in the record 420, the standard deviation keyword in the record 440, and the average keyword in record 445.

Control then continues to block 515 where the debugger 150 determines whether the command previously received at block 505 is a loop breakpoint command, e.g., the command 350. If the determination at block 515 is true, then the command is a loop breakpoint command, so control continues to block 520 where the debugger 150 finds the loop start statement, the loop body statement, and the loop end statement associated with the loop breakpoint command. Control then continues to block 525 where the debugger 150 creates a record or records in the breakpoint table 156 corresponding to the command, as previously described above with reference to FIG. 4. Control then continues to block 530 where the debugger 150 sets the breakpoint in the program 168 that was requested by the command. Control then continues to block 599 where the logic of FIG. 5 returns.

If the determination at block 515 is false, then the received command was not a loop breakpoint command, so control continues from block 515 to block 525, as previously described above.

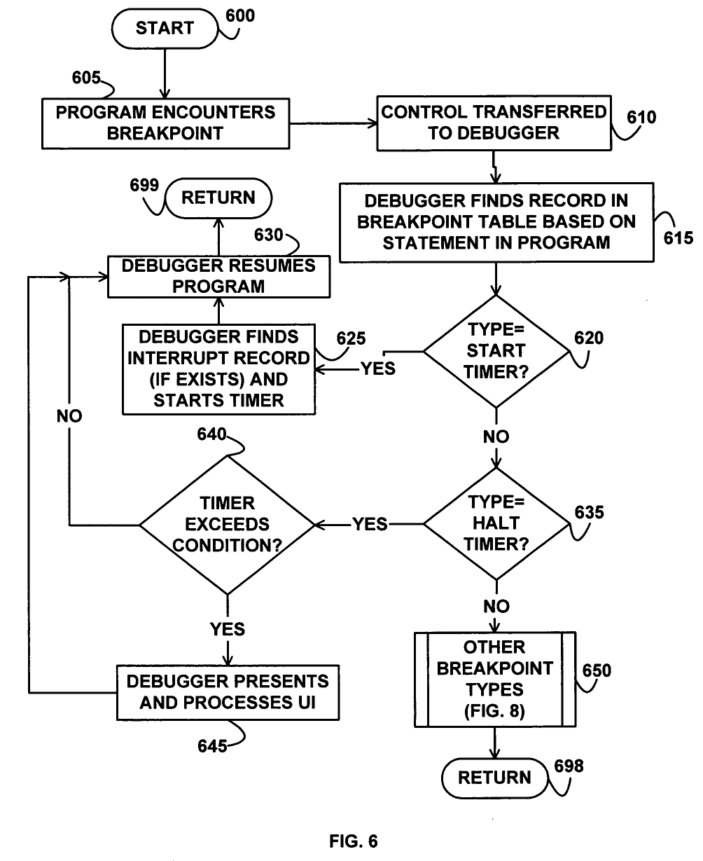

FIG. 6 depicts a flowchart of example processing for handling breakpoints, according to an embodiment of the invention. Control begins at block 600. Control then continues to block 605 where the program 168 encounters a breakpoint. Control then continues to block 610 where control is transferred to the debugger 150. Control then continues to block 615 where the debugger 150 finds a record in the breakpoint table 156 based on the statement in the program 168 that encountered the breakpoint, using the statement field 470 in the breakpoint table 156.

Control then continues to block 620 where the debugger 150 determines whether the type of breakpoint encountered is a start timer breakpoint, by reading the breakpoint type field 465 in the found record in the breakpoint table 156. If the determination at block 620 is true, then the breakpoint encountered is a start timer breakpoint, so control continues to block 625 where the debugger 150 finds an associated record in the breakpoint table 156 having the same timer 475 and a type 465 of interrupt (if such a record exists) and starts the timer indicated in the timer field 475. If the record exists, the debugger 150 initializes the timer 475 to expire after the time indicated in the condition field 480 of the record having the type 465 of interrupt. If the associated record with a type 465 of interrupt does not exist, then the debugger 150 starts the timer 475 to continue timing indefinitely, or until canceled. Control then continues to block 630 where the debugger 150 resumes execution of the program 168. Control then continues to block 699 where the logic of FIG. 6 returns.

If the determination at block 620 is false, then the breakpoint type 465 in the found record is not a start timer breakpoint, so control continues to block 635 where the debugger 150 determines whether the breakpoint type 465 in the found record is a halt timer breakpoint. If the determination at block 635 is true, then the breakpoint type 465 in the found record is a halt timer breakpoint, so control continues from block 635 to block 640 where the debugger 150 determines whether the timer indicated in the timer field 475 has exceeded the condition 480 indicated in the found record. If the determination at block 640 is true, then the timer exceeds the condition 480, so control continues to block 645 where the debugger 150 presents the user interface and processes commands from the user interface. Control then continues to block 630, as previously described above.

If the determination at block 640 is false, then the timer 475 does not exceed the condition 480, so control continues from block 640 to block 630, as previously described above.

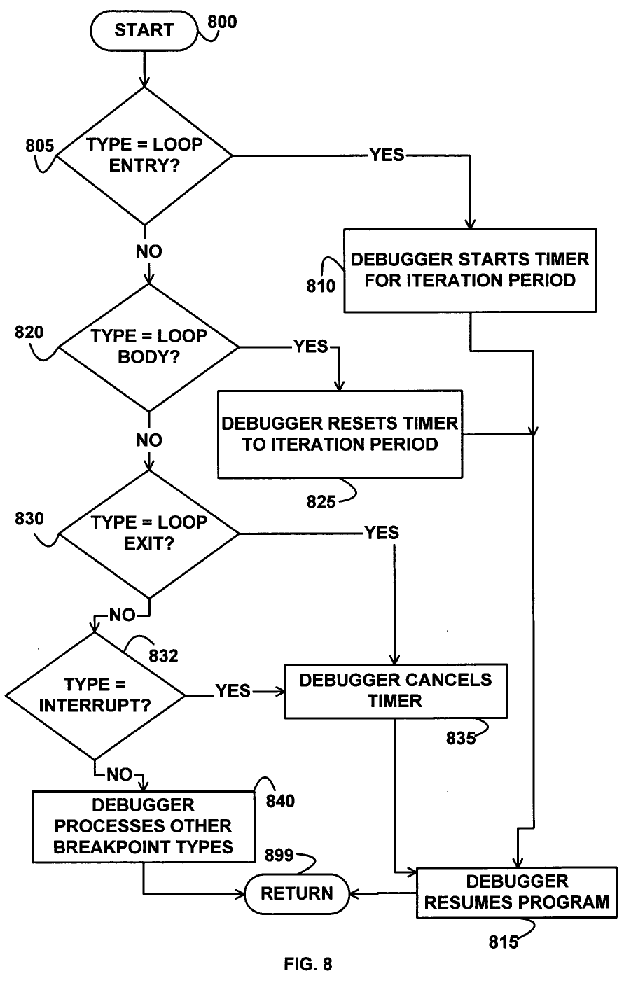

If the determination at block 635 is false, then the breakpoint type 465 is not a halt timer breakpoint, so control continues from block 635 to block 650 where the debugger 150 processes other breakpoint types, as further described below with reference to FIG. 8. Control then continues to block 698 where the logic of FIG. 6 returns.

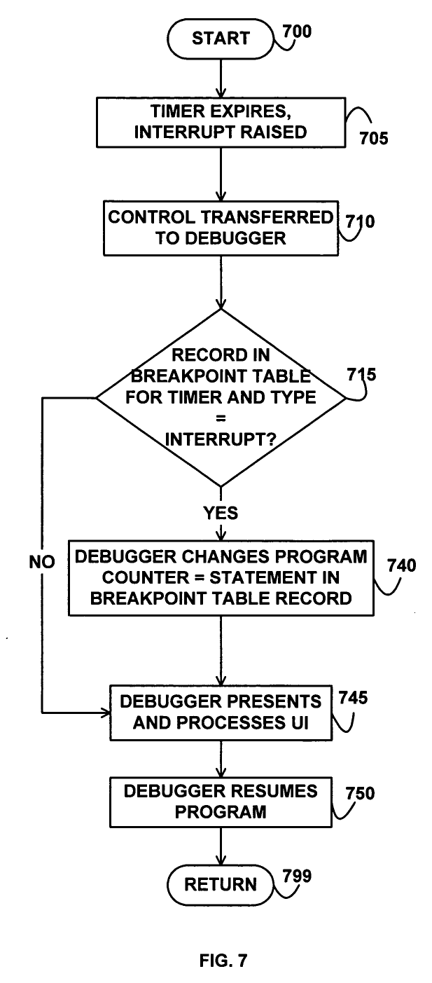

FIG. 7 depicts a flowchart of example processing for handling timer expiration interrupts, according to an embodiment of the invention. Control begins at block 700. Control then continues to block 705 where an interrupt is raised as a result of the timer 172 expiring. Control then continues to block 710 where control is transferred to the debugger 150. Control then continues to block 715 where the debugger 150 determines whether a record exists in the breakpoint table 156 that is associated with the name of the timer 172 that expired and has a type 465 of interrupt based on the breakpoint type field 465 and the timer field 475. If the determination at block 715 is true, then an interrupt record associated with the timer that expired exists in the breakpoint table 156, so control continues to block 740 where the debugger 150 changes the program counter to be the statement 470 in the found breakpoint table record. The program counter indicates the statement in the program 168 at which execution of the program 168 will continue once the program 168 resumes. Control then continues to block 745 where the debugger 150 presents the user interface 300 and processes any commands from the user interface. Control then continues to block 750 where the debugger 150 resumes execution of the program 168. Control then continues to block 799 where the logic of FIG. 7 returns.

If the determination at block 715 is false, then an interrupt record with a timer 475 that matches the timer that expired does not exist in the breakpoint table 156, so control continues from block 715 to block 745, as previously described above.

FIG. 8 depicts a flowchart of example processing for handling loop breakpoints, according to an embodiment of the invention. Control begins at block 800. Control then continues to block 805 where the debugger 150 determines whether the breakpoint type 465 in the found record indicates a loop entry breakpoint. If the determination at block 805 is true, then the breakpoint type 465 is a loop entry breakpoint, so control continues from block 805 to block 810 where the debugger 150 starts the timer 475 for the iteration period indicated in the condition 480. Control then continues to block 815 where the debugger 150 resumes execution of the program 168. Control then continues to block 899 where the logic of FIG. 8 returns.

If the determination at block 805 is false, then the breakpoint type 465 is not a loop entry breakpoint, so control continues to block 820 where the debugger 150 determines whether the breakpoint type 465 is a loop body breakpoint. If the determination at block 820 is true, then the breakpoint type 465 is a loop body breakpoint, so control continues to block 825 where the debugger 150 resets the timer 475 to the iteration period indicated in the condition 480. Control then continues to block 815, as previously described above.

If the determination at block 820 is false, then the breakpoint type 465 is not a loop body breakpoint so control continues to block 830 where the debugger 150 determines whether the breakpoint type 465 is a loop exit breakpoint. If the determination at block 830 is true, then the breakpoint type 465 is a loop exit breakpoint, so control continues to block 835 where the debugger 150 cancels the timer 475. Control then continues to block 815, as previously described above.

If the determination at block 830 is false, then the breakpoint type 465 is not a loop exit breakpoint, so control continues to block 840 where the debugger 150 processes any other breakpoint types. Control then continues to block 899 where the logic of FIG. 8 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
setting a first breakpoint and a second breakpoint in a program;
starting a timer in response to the program encountering the first breakpoint; and
determining whether the timer exceeds a condition in response to the program encountering the second breakpoint.

2. The method of claim 1, further comprising:
resuming the program if the determining is false.

3. The method of claim 1, further comprising:
halting the program if the determining is true.

4. The method of claim 1, further comprising:
retrieving the condition from the program based on a keyword.

5. The method of claim 1, wherein the condition further comprises a value retrieved from the program based on a keyword.

6. The method of claim 1, wherein the condition further comprises a threshold.

7. The method of claim 1, wherein the condition further comprises:
an estimate of an execution time of an operation performed by the program.

8. The method of claim 1, wherein the condition further comprises:
a function of historical execution times of operations performed by the program.

9. The method of claim 8, wherein the function further comprises an average.

10. The method of claim 8, wherein the function further comprises a standard deviation.

11. A signal-bearing medium encoded with instructions, wherein the instructions when executed comprise:
setting a first breakpoint at a first statement in a program;
setting a second breakpoint at a second statement in the program;
in response to the program encountering the first breakpoint, initializing a timer to interrupt the program upon the timer reaching an interrupt condition; and
in response to the program encountering the second breakpoint, determining whether the timer exceeds a halt condition.

12. The signal-bearing medium of claim 11, further comprising:
if the determining is true, halting the program and presenting a debug user interface; and
if the determining is false, resuming the program.

13. The signal-bearing medium of claim 11, further comprising:
in response to the interrupt, changing a program counter to a specified third statement in the program.

14. The signal-bearing medium of claim 11, further comprising:
deactivating the timer if the program encounters a specified third statement in the program without the timer reaching the interrupt condition.

15. The signal-bearing medium of claim 11, wherein the condition further comprises a specified time threshold.

16. A method for configuring a computer, comprising:
configuring the computer to find a loop entry statement in a program, a loop body statement in the program, and a loop exit statement in the program; and
configuring the computer to set a loop entry breakpoint at the loop entry statement, a loop body breakpoint at the loop body statement, and a loop exit breakpoint at the loop exit statement.

17. The method of claim 16, further comprising:
configuring the computer to start a timer for an iteration period in response to the program encountering the loop entry breakpoint.

18. The method of claim 17, further comprising:
configuring the computer to reset the timer to the iteration period in response to the program encountering the loop body breakpoint.

19. The method of claim 17, further comprising:
configuring the computer to cancel the timer in response to the program encountering the loop exit breakpoint.

20. The method of claim 16, further comprising:
configuring the computer to find the loop entry statement in the program, the loop body statement in the program, and the loop exit statement in the program in response to a debug command.
